(19) United States
(12) Patent Application Publication
(10) Pub. No.: US 2022/0343153 A1
(43) Pub. Date: Oct. 27, 2022

(54) ARTIFICIAL NEURAL NETWORK RETRAINING IN MEMORY

(71) Applicant: Micron Technology, Inc., Boise, ID (US)

(72) Inventors: Poorna Kale, Folsom, CA (US); Saideep Tiku, Fort Collins, CO (US)

(21) Appl. No.: 17/240,578

(22) Filed: Apr. 26, 2021

(51) Int. Cl. G06N 3/08; G06N 3/04

(52) U.S. Cl. CPC G06N 3/08; G06N 3/04

(57) ABSTRACT

An artificial neural network can be allocated to memory and operated. Performance of the artificial neural network can be periodically evaluated. The evaluation can include inputting a representative dataset to the artificial neural network and comparing an output of the artificial neural network to a known output for the representative dataset. The artificial neural network can be retrained at least partially in response to the evaluation yielding a sub-threshold result.

### TECHNICAL FIELD

The present disclosure relates generally to memory, and more particularly to apparatuses and methods associated with artificial neural network retraining in memory.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. including, but not limited to personal computers, portable memory sticks, digital cameras, cellular telephones, portable music players such as MP3 players, movie players, and other electronic devices. Memory cells can be arranged into arrays, with the arrays being used in memory devices.

### BRIEF DESCRIPTION OF THE DRAWINGS

FIG. 1 is a block diagram of an apparatus in the form of a computing system including a memory device in accordance with a number of embodiments of the present disclosure.

FIG. 2 is a flow diagram for artificial neural network retraining in accordance with a number of embodiments of the present disclosure.

FIG. 3 is a flow diagram of a method for artificial neural network retraining in memory in accordance with a number of embodiments of the present disclosure.

FIG. 4 illustrates an example computer system within which a set of instructions, for causing the machine to perform various methodologies discussed herein, can be executed.

### DETAILED DESCRIPTION

The present disclosure includes apparatuses and methods related to artificial neural network (“ANN”) retraining in memory. Remotely deployed sensors may be used with networking infrastructure (e.g., 5G networks), smart cameras, radar, equipment designed for space or subsea exploration. Such sensors can be challenging and/or expensive to repair and may face questionable mean time to failure. It is desirable for memory and compute subsystems deployed under such harsh conditions to be resilient to various sources of failure that may arise due to, for example, aging, alpha particle strikes, swift changes in environmental conditions, etc. However, failure of such systems may ultimately be inevitable. Therefore, it is desirable for memory subsystems to adapt in-situ to improve mean time to failure of the overall system.

Redundancy in memory and compute subsystems is often seen as a failsafe solution to problems associated with random bit flips and freezes in memory. However, redundancy has a significant cost. Minor errors or variations in ANNs (e.g., errors in inputs and/or weights) used with deep learning-based applications deployed in the sensing space may not always lead to erroneous results. For example, such errors may occur on non-critical compute nodes of an ANN application graph. However, if the same error persists for a given bit in memory occupied by the same weights in the ANN, there may come a time when the erroneous bit is on a critical path for the correct execution of the ANN model. Such errors may specifically bias a particular class and/or portion of an ANN application.

Aspects of the present disclosure address the above and other deficiencies. For instance, in-situ retraining of the ANN can be used to extend the lifetime and/or reliability of the system implementing the ANN. Some embodiments include evaluating performance of the ANN post-deployment. The performance evaluation can make use of a representative dataset as input to the ANN and make use of known outputs for the representative dataset from the ANN. The actual output of the ANN based on the representative dataset input can be compared to the known output. If the performance evaluation produces a sub-threshold result, then the ANN can be retrained in the field using the same physical memory (including any errors therein). Once the ANN has been retrained, it can be put back into operation. A frequency with which the ANN is retrained can depend on the reliability and/or lifetime expectations of the system implementing the ANN. For example, networking infrastructure may have longer lifetime expectations with relatively lesser accuracy expectations. As another example, autonomous vehicles or robots may have relatively greater accuracy expectations with relatively lesser lifetime expectations. A host system can indicate expectations regarding lifetime and/or accuracy to the memory device on which the ANN is deployed.

An ANN can provide learning by forming probability weight associations between an input and an output. The probability weight associations can be provided by a plurality of nodes that comprise the ANN. The nodes together with weights, biases, and activation functions can be used to generate an output of the ANN based on the input to the ANN. As used herein, artificial intelligence refers to the ability to improve a machine through “learning” such as by storing patterns and/or examples which can be utilized to take actions at a later time. Deep learning refers to a device's ability to learn from data provided as examples. Deep learning can be a subset of artificial intelligence. Artificial neural networks, among other types of networks, can be classified as deep learning.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

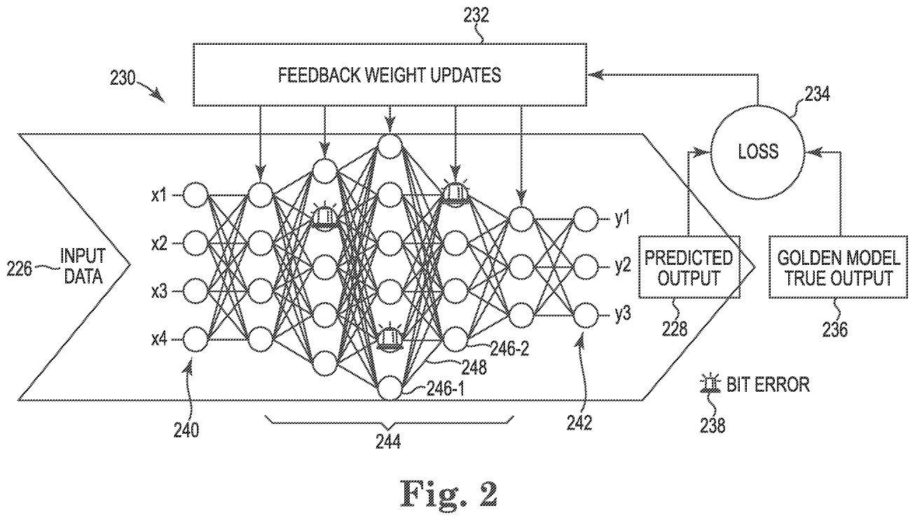

The figures herein follow a numbering convention in which the first digit or digits correspond to the drawing figure number and the remaining digits identify an element or component in the drawing. Analogous elements within a Figure may be referenced with a hyphen and extra numeral or letter. See, for example, elements 246-1, 246-2 in FIG. 2. Such analogous elements may be generally referenced without the hyphen and extra numeral or letter. For example, elements 246-1, 246-2 in FIG. 2 may be collectively referenced as 246. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

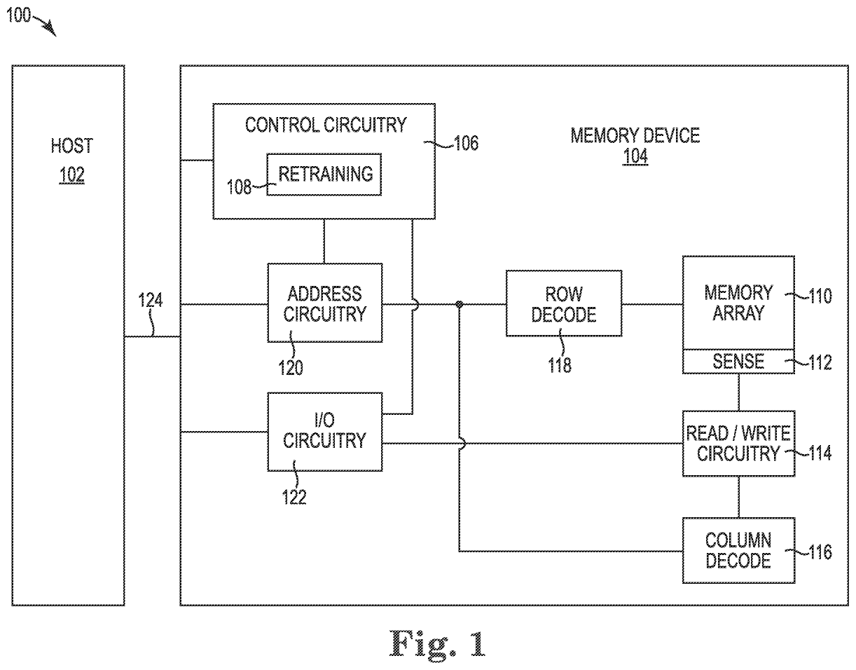

FIG. 1 is a block diagram of an apparatus in the form of a computing system 100 including a memory device in accordance with a number of embodiments of the present disclosure. The memory device 104 is coupled to a host 102 via an interface 124. As used herein, a host 102, a memory device 104, or a memory array 110, for example, might also be separately considered to be an “apparatus.” The interface 124 can pass control, address, data, and other signals between the memory device 104 and the host 102. The interface 124 can include a command bus (e.g., coupled to the control circuitry 106), an address bus (e.g., coupled to the address circuitry 120), and a data bus (e.g., coupled to the input/output (I/O) circuitry 122). In some embodiments, the command bus and the address bus can be comprised of a common command/address bus. In some embodiments, the command bus, the address bus, and the data bus can be part of a common bus. The command bus can pass signals between the host 102 and the control circuitry 106 such as clock signals for timing, reset signals, chip selects, parity information, alerts, etc. The address bus can pass signals between the host 102 and the address circuitry 120 such as logical addresses of memory banks in the memory array 110 for memory operations. The interface 124 can be a physical interface employing a suitable protocol. Such a protocol may be custom or proprietary, or the interface 124 may employ a standardized protocol, such as Peripheral Component Interconnect Express (PCIe), Gen-Z interconnect, cache coherent interconnect for accelerators (CCIX), etc. In some cases, the control circuitry 106 is a register clock driver (RCD), such as RCD employed on an RDIMM or LRDIMM.

The memory device 104 and host 102 can be a satellite, a communications tower, a personal laptop computer, a desktop computer, a digital camera, a mobile telephone, a memory card reader, an Internet-of-Things (IoT) enabled device, an automobile, among various other types of systems. For clarity, the system 100 has been simplified to focus on features with particular relevance to the present disclosure. The host 102 can include a number of processing resources (e.g., one or more processors, microprocessors, or some other type of controlling circuitry) capable of accessing the memory device 104.

The memory device 104 can provide main memory for the host 102 or can be used as additional memory or storage for the host 102. By way of example, the memory device 104 can be a dual in-line memory module (DIMM) including memory arrays 110 operated as double data rate (DDR) DRAM, such as DDR5, a graphics DDR DRAM, such as GDDR6, or another type of memory system. Embodiments are not limited to a particular type of memory device 104. Other examples of memory arrays 110 include RAM, ROM, SDRAM, LPDRAM, PCRAM, RRAM, flash memory, and three-dimensional cross-point, among others. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

The control circuitry 106 can decode signals provided by the host 102. The control circuitry 106 can also be referred to as a command input and control circuit and can represent the functionality of different discrete ASICs or portions of different ASICs depending on the implementation. The signals can be commands provided by the host 102. These signals can include chip enable signals, write enable signals, and address latch signals, among others, that are used to control operations performed on the memory array 110. Such operations can include data read operations, data write operations, data erase operations, data move operations, etc. The control circuitry 106 can comprise a state machine, a sequencer, and/or some other type of control circuitry, which may be implemented in the form of hardware, firmware, or software, or any combination of the three.

Data can be provided to and/or from the memory array 110 via data lines coupling the memory array 110 to input/output (I/O) circuitry 122 via read/write circuitry 114. The I/O circuitry 122 can be used for bi-directional data communication with the host 102 over an interface. The read/write circuitry 114 is used to write data to the memory array 110 or read data from the memory array 110. As an example, the read/write circuitry 114 can comprise various drivers, latch circuitry, etc. In some embodiments, the data path can bypass the control circuitry 106.

The memory device 104 includes address circuitry 120 to latch address signals provided over an interface. Address signals are received and decoded by a row decoder 118 and a column decoder 116 to access the memory array 110. Data can be read from memory array 110 by sensing voltage and/or current changes on the sense lines using sensing circuitry 112. The sensing circuitry 112 can be coupled to the memory array 110. The sensing circuitry 112 can comprise, for example, sense amplifiers that can read and latch a page (e.g., row) of data from the memory array 110. Sensing (e.g., reading) a bit stored in a memory cell can involve sensing a relatively small voltage difference on a pair of sense lines, which may be referred to as digit lines or data lines.

The memory array 110 can comprise memory cells arranged in rows coupled by access lines (which may be referred to herein as word lines or select lines) and columns coupled by sense lines (which may be referred to herein as digit lines or data lines). Although the memory array 110 is shown as a single memory array, the memory array 110 can represent a plurality of memory arrays arraigned in banks of the memory device 104. The memory array 110 can include a number of memory cells, such as volatile memory cells (e.g., DRAM memory cells, among other types of volatile memory cells) and/or non-volatile memory cells (e.g., RRAM memory cells, among other types of non-volatile memory cells).

The control circuitry 106 can also include retraining circuitry 108. In some embodiments, the retraining circuitry 108 comprises an application specific integrated circuit (ASIC) configured to perform the retraining examples described herein. In some embodiments, the retraining circuitry 108 represents functionality of the control circuitry 106 that is not embodied in separate discrete circuitry. The term “controller” is used herein to refer to the functionality of the host 102, the control circuitry 106, and/or the retraining circuitry 108.

The controller can be configured to periodically evaluate performance of an ANN at a predefined frequency. The ANN can be allocated to the memory device 104. For example, values indicative of elements comprising topology, weights, biases, etc. of the ANN can be stored in the memory array 110. The predefined frequency can be a user-defined parameter based at least in part on reliability and/or lifetime expectations of the computing system 100. The controller can be configured to retrain the ANN at least partially in response to a sub-threshold result of the periodic performance evaluation (as a result of any individual performance evaluation). The computing system 100 can store a representative dataset and a known output of the ANN in response to the representative dataset being input thereto. The representative dataset and/or the known output can be stored in the memory array 110 or in different memory (not specifically illustrated) separate from the memory array 110. To perform the periodic performance evaluation, the controller can be configured to input the representative dataset to the ANN and compare an output of the ANN to the known output, as described in more detail with respect to FIG. 2.

FIG. 2 is a flow diagram for ANN retraining in accordance with a number of embodiments of the present disclosure. The ANN 230 can receive input data 226 and can generate an output 228, which can be referred to as a predicted output because it is a prediction of the result of the classification, identification, or analysis performed on the input data 226 by the ANN 230. The input data 226 can be input to the nodes of the input layer 240.

The input 226 can be data that the ANN 230 is designed to perform an operation with respect to, such as classify, identify, analyze, etc. Non-limiting examples of such input data include images, video, and patterns. The input 226 data can be represented as a matrix. A convolution layer can be represented as a matrix of lesser dimensionality than the input data. A convolution layer can perform a convolution operation on a portion of the input 226 proportional to the convolution layer. A convolution layer can be analogized to an image filter that scans a few pixels at a time to create a feature map that predicts a class to which each feature belongs, for example. A convolution layer can output a result of the convolution to another layer. A fully connected layer can take the results of other layers as input and use them to classify, identify, or analyze the input 226. Fully connected layers in series can first take the output of previous layers and “flatten” the output to a single vector that can be input to a subsequent stage, take inputs from feature analysis and apply weights to predict a correct label, and give final probabilities for each label. The label is the result of the classification, identification, or analysis performed by the ANN 230.

Examples of the output 228 include an identification of an object in an image, where the image is the input data 226. The ANN 230 can include layers of nodes 246 including an initial or input layer 240 and a final or output layer 242 with intermediate layers 244 therebetween. The nodes 246 of the output layer 242 can provide signals that represent the output 228 of the ANN 230.

Each node 246 of the ANN 230 can be coupled to adjacent nodes 246. For example, a first node 246-1 can be coupled to a second node 246-2, as illustrated. Signals can be provided from the nodes of a previous layer to connected nodes of a subsequent layer (left to right as illustrated). For example, a signal can be provided from the first node 246-1 to the second node 246-2 and the connection 248 therebetween can be assigned a weight. In some embodiments, each connection in the ANN 230 can have an individual weight assigned thereto.

A node 246 can provide (or not provide) an input signal to each of the nodes to which it is coupled. For a given pair of coupled nodes, that signal can be combined with a weight assigned to the connection therebetween. For example, a weight assigned to the connection 248 between the first node 246-1 and the second node 246-2 can be combined with the corresponding signal sent from the first node 246-1 to the second node 246-2. For example, the weight can be multiplied with the signal provided from the first node 246-1 to the second node 246-2. A given node 246 can have a quantity of inputs thereto from a corresponding quantity of nodes coupled thereto. The node 246 can sum the product of the signals input thereto and the corresponding weights assigned to the connections. A bias can be added to the sum. The addition (e.g., sum of the bias and the sum of the product of the signals and the corresponding weights) can be performed by the nodes 246. The result of the addition can be used in an activation function to determine whether the corresponding node will provide a signal to each of the nodes to which the corresponding node is coupled.

A topology of the ANN 230 describes the coupling of the nodes 246. The topology of the ANN 230 also describes the quantity of nodes 230. The topology of the ANN 230 further describes the layers 240, 244, 242 of the ANN 230 and/or the quantity of the layers 240, 244, 242.

To evaluate performance of the ANN 230, modeled data can be used as the input data 226. Such modeled data can be referred to as a “golden model”. If the ANN 230 is functioning properly, the golden model should cause the ANN 230 to generate a known output 236 (e.g., “golden model true output”). The known output 236 can be stored in advance of operation of the ANN 230. The actual output 228 of the ANN 230 operating on the golden model as input data 226 can be compared to the known output 236 to evaluate performance of the ANN 230.

The result of the performance evaluation can be the difference 234 (e.g., “loss”) between the output 228 and the known output 236. The difference 234 can be compared to a threshold value to determine whether the ANN 230 has sub-threshold (e.g., unacceptable) performance. A sub-threshold result is a greater difference between the predicted output 228 and the true output 236 of the ANN than a predefined threshold difference. In response to a sub-threshold performance evaluation, the ANN 230 can be retrained 232. Retraining can include determining the difference 234 between the predicted output 228 and the true output 236 and applying corrections to reduce or minimize that difference 234. Retraining can include updating the weights and/or the biases of the ANN 230. Retraining can be performed in the field (e.g., by a controller of the computing system 100 illustrated in FIG. 1). One reason for sub-threshold performance of the ANN 230, particularly where such sub-threshold performance did not previously exist, is the occurrence of errors 238 in the physical memory to which the ANN 230 is allocated.

Errors 238 (e.g., “bit errors”) are illustrated. The errors 238 are shown as appearing in various nodes 246. The error 238 occurs in physical memory and is therefore introduced into the ANN 230. Examples of errors 238 include bit errors and bit freezes. A bit error is the result of a memory cell being unreadable or storing incorrect data. Bit errors can be caused defects in the memory cell, defects in the programming process, or other phenomena. A bit freeze is the result of a memory cell being programmed to a particular state and that state not being changeable (e.g., erasable or reprogrammable). A bit freeze can be the result of aging, over-programming, or other phenomena. Errors in the memory (e.g., in a memory cell) can cause the value (e.g., weight) stored in a memory cell (or group of memory cells) to be read incorrectly, which may cause the ANN 230 to produce unexpected, incorrect, and/or unreliable results. The magnitude or effect (if any) of the error can be dependent upon where in the ANN the error occurs. Different types of memory devices can experience different types of errors and/or can experience different quantities of errors at a given age of the memory device. The error 238 can take the form of a modification to the weights, biases, nodes, and/or layers, among other characteristics of the ANN 230. For example, the error 230 can cause a modification in the ANN 230 to an intended value of a weight and/or bias. In some instances, the error 238 may cause a node and/or layer to be unintentionally added to or removed from the ANN 230.

At least one embodiment of the present disclosure includes applying the predefined threshold for evaluating performance of the ANN 230 irrespective of a quantity of errors 238 present in the memory. The ANN 230 can be retrained based on the performance (or lack thereof) regardless of how many bit errors 238 (if any) are present in the physical memory to which the ANN 230 is allocated. In some embodiments, the errors 238 are detected in the memory (e.g., by error detection circuitry, such as a cyclic redundancy check engine). In some embodiments, the errors 238 are not detected in the memory. Retraining the ANN 230 can include mapping weights to memory cells of the memory device without adjusting the weights mapped to memory cells that have the errors. In other words, once the retraining has occurred and the revised weights for the ANN 230 are determined via the retraining, they can be mapped to (e.g., written to) the memory cells without accounting for any memory cells that have an error, whether that error 238 is detected or not. No changes to the retrained weights and/or biases are made based on the error status of any memory cell. Rather, the retrained ANN 230 “learns” to account for the presence of errors. The ANN 230 compensates, through the retraining process (sometimes involving multiple retrainings of the ANN 230), for the errors 238.

Some approaches to addressing errors in memory with respect to the operation of an ANN may include the use of redundant memory. For example, if a block of memory has an error, use of that block of memory may be discontinued and it can effectively be replaced with a redundant block of memory. Such approaches may be referred to as overprovisioning the ANN with memory. However, such approaches are inefficient in terms of the cost to implement the ANN and the physical size of the device used to implement the ANN. In contrast, at least one embodiment of the present disclosure allows for errors in memory to be addressed without relying on redundant memory. For example, the physical portion (e.g., block) of memory containing the error 238 is still used to implement the ANN in each retraining rather than being excluded and replaced with redundant memory.

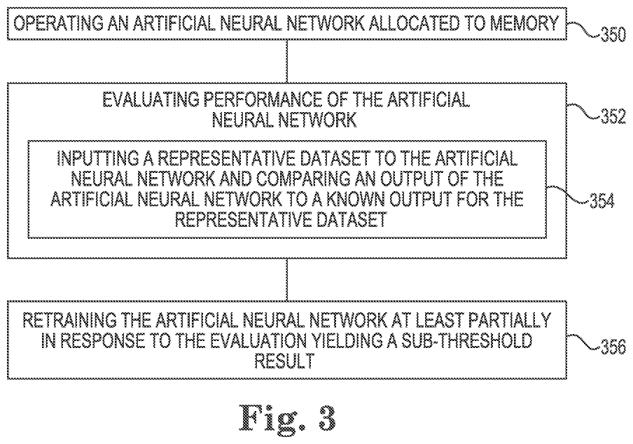

FIG. 3 is a flow diagram of a method for ANN retraining in memory in accordance with a number of embodiments of the present disclosure. The method can be performed by processing logic that can include hardware (e.g., a processing device, circuitry, dedicated logic, programmable logic, microcode, hardware of a device, integrated circuit, etc.), software (e.g., instructions run or executed on a processing device), or a combination thereof. In some embodiments, the method is performed by the control circuitry (e.g., control circuitry 106 illustrated in FIG. 1). Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 350, the method can include operating an ANN allocated to memory. At block 352, the method can include evaluating performance of the ANN. The performance evaluation of block 352 can include inputting a representative dataset to the ANN and comparing an output of the ANN to a known output for the representative dataset at block 354. In some embodiments, the evaluation of the performance of the ANN can be performed periodically. An indication of a desired frequency of the periodic evaluation can be received from a host (e.g., from a user via the host) and the periodic evaluation can be performed at the desired frequency. At block 356, the method can include retraining the ANN at least partially in response to the performance evaluation yielding a sub-threshold result. Although not specifically illustrated, the method can include evaluating performance of the retrained ANN (once, several times, or periodically) and determining whether to retrain the ANN again based on the results of the performance evaluation.

In some embodiments, the method can include detecting an error in the memory. In such embodiments, retraining can occur at least partially in response to the error (as well as at least partially in response to the sub-threshold result of the performance evaluation). The retraining can account for the error without remapping storage of weights in the memory (e.g., without changing a weight mapped to a memory cell having an error).

The memory can be part of a remote system (e.g., not accessible by technicians or other computing infrastructure). The method can be performed by the remote system, including evaluating performance of the ANN and retraining the ANN. Such embodiments can extend the lifetime of the remote system (e.g., by flattening a failure curve of the remote system) and reduce costs of operating the remote system.

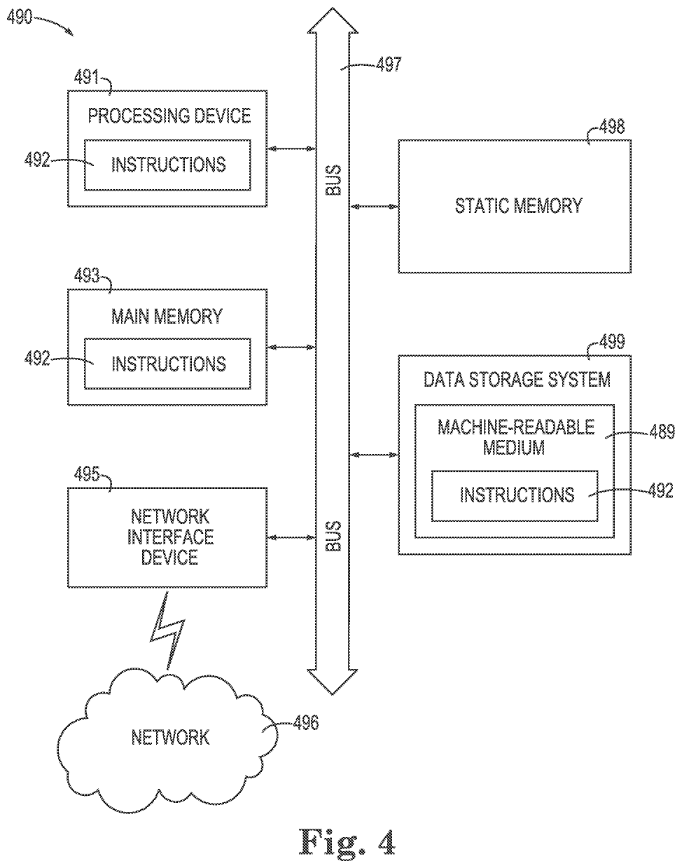

FIG. 4 illustrates an example computer system 490 within which a set of instructions, for causing the machine to perform various methodologies discussed herein, can be executed. In various embodiments, the computer system 490 can correspond to a system (e.g., the computing system 100 of FIG. 1) that includes, is coupled to, or utilizes a memory sub-system (e.g., the memory device 104 of FIG. 1) or can be used to perform the operations of control circuitry. In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 490 includes a processing device 491, a main memory 493 (e.g., read-only memory (ROM), flash memory, dynamic random access memory (DRAM) such as synchronous DRAM (SDRAM) or Rambus DRAM (RDRAM), etc.), a static memory 497 (e.g., flash memory, static random access memory (SRAM), etc.), and a data storage system 499, which communicate with each other via a bus 497.

The processing device 491 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 491 can also be one or more special-purpose processing devices such as an application specific integrated circuit (ASIC), a field programmable gate array (FPGA), a digital signal processor (DSP), network processor, or the like. The processing device 491 is configured to execute instructions 492 for performing the operations and steps discussed herein. The computer system 490 can further include a network interface device 495 to communicate over the network 496.

The data storage system 499 can include a machine-readable storage medium 489 (also known as a computer-readable medium) on which is stored one or more sets of instructions 492 or software embodying any one or more of the methodologies or functions described herein. The instructions 492 can also reside, completely or at least partially, within the main memory 493 and/or within the processing device 491 during execution thereof by the computer system 490, the main memory 493 and the processing device 491 also constituting machine-readable storage media.

In at least one embodiment, the instructions 492 can be executed to implement functionality corresponding to the host 102 and/or the memory device 104 of FIG. 1. The instructions 492 can be executed to cause the machine to receive a first definition of a threshold for results of a period performance evaluation of an ANN, receive a second definition of at least one of a reliability expectation and a lifetime expectation of the system 490, and operate the ANN allocated to the memory device. The instructions 492 can be executed to perform periodic performance evaluations on the ANN at a frequency based on the second definition. The instructions 492 can be executed to retrain the ANN at least partially in response to a particular periodic performance evaluation not meeting the first definition. The instructions 492 can be executed to operate the retrained ANN.

The instructions 492 can be executed to detect errors in the memory. The instructions 492 to retrain the ANN can be executed to cause the ANN to be retrained irrespective of the detected errors. The instructions 492 can be executed to cause weights of the ANN to be stored in memory cells of a memory device (e.g., main memory 493, static memory 498, and/or the data storage system 499) prior to operation of the ANN and to cause weights of the retrained ANN to be stored in the same memory cells. If errors in the memory cells have been detected, the weights can be stored in the same memory cells regardless of the errors.

A representative dataset and a known output of the ANN responsive to input of the representative dataset can be stored in memory (e.g., main memory 493, static memory 498, and/or the data storage system 499). The instructions 492 can be executed to perform the periodic performance evaluation of the ANN by inputting the representative dataset to the ANN and comparing an output of the ANN to the known output.

A table can be stored in memory (e.g., main memory 493, static memory 498, and/or the data storage system 499). The table can include correspondences between respective frequencies of the periodic performance evaluation and respective reliability expectations and respective lifetime expectations. The instructions 492 can be executed to select the frequency from the table based on the second definition. The definitions can be received, for example, from a user (e.g., via the network 496). The ability to receive such definitions is useful in allowing the system (and the operation of the ANN) to be designed for generic use and then allowing users to specify parameters for operation and retraining of the ANN based on their use case.

While the machine-readable storage medium 489 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combinations of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
operating an artificial neural network allocated to memory;
evaluating performance of the artificial neural network;
wherein evaluating comprises inputting a representative dataset to the artificial neural network and comparing an output of the artificial neural network to a known output for the representative dataset; and
retraining the artificial neural network at least partially in response to the evaluation yielding a sub-threshold result.

2. The method of claim 1, further comprising evaluating performance of the artificial neural network after retraining; and
determining whether to retrain the artificial neural network again based on results of the evaluation.

3. The method of claim 1, wherein the memory is part of a remote system;
wherein the method is performed by the remote system; and
wherein evaluating and retraining comprises evaluating and retraining by the remote system.

4. The method of claim 1, wherein evaluating comprises periodically evaluating performance of the artificial neural network.

5. The method of claim 4, further comprising receiving an indication of a desired frequency of the periodic evaluation from a host of the memory; and
wherein periodically evaluating comprises periodically evaluating at the desired frequency.

6. The method of claim 1, further comprising detecting an error in the memory; and
wherein retraining further comprises retraining at least partially in response to the error.

7. The method of claim 6, wherein retraining accounts for the error without remapping storage of weights in the memory.

8. The method of claim 6, wherein detecting the error comprises detecting a bit error or bit freeze in the memory.

9. An apparatus, comprising:
a memory device; and
controller coupled to the memory device and configured to:
periodically evaluate performance of an artificial neural network at a predefined frequency, wherein the artificial neural network is allocated to the memory device; and
retrain the artificial neural network at least partially in response to a sub-threshold result of the periodic performance evaluation.

10. The apparatus of claim 9, wherein the predefined frequency is a user-defined parameter based at least in part on reliability or lifetime expectations of the apparatus.

11. The apparatus of claim 9, wherein the apparatus stores a representative dataset and a known output of the artificial neural network for the representative dataset; and
wherein the controller is configured to input the representative dataset to the artificial neural network and compare an output of the artificial neural network to the known output as the periodic performance evaluation.

12. The apparatus of claim 11, wherein the sub-threshold result comprises a greater difference between the output of the artificial neural network for the representative dataset and the known output than a predefined threshold.

13. The apparatus of claim 12, wherein the controller is configured to apply the predefined threshold irrespective of a quantity of bit errors present in the memory device.

14. The apparatus of claim 9, wherein the controller is configured to retrain the artificial neural network irrespective of a quantity of bit errors present in the memory device.

15. The apparatus of claim 9, wherein the controller is configured to detect a plurality of bit errors in the memory device; and
wherein the controller being configured to retrain the artificial neural network comprises the controller being configured to map weights to memory cells of the memory device without adjusting weights mapped to particular memory cells corresponding to the bit errors.

16. A non-transitory machine-readable medium storing machine-readable instructions, which when executed by a machine, cause the machine to:
receive a first definition of a threshold for results of a periodic performance evaluation of an artificial neural network;
receive a second definition of at least one of a reliability expectation and a lifetime expectation of a memory device;
operate an artificial neural network allocated to the memory device;
perform the periodic performance evaluation at a frequency based on the second definition; and
retrain the artificial neural network at least partially in response to a particular periodic performance evaluation not meeting the first definition.

17. The medium of claim 16, further storing a table comprising correspondences between respective frequencies of the periodic performance evaluation and respective reliability expectations and respective lifetime expectations; and
further storing instructions to select the frequency from the table based on the second definition.

18. The medium of claim 16, further comprising instructions to detect a plurality of bit errors in the memory device; and
wherein the instructions to retrain the artificial neural network comprise instructions to retrain the artificial neural network irrespective of the plurality of errors.

19. The medium of claim 16, further storing a representative dataset and a known output of the artificial neural network for the representative dataset; and
further storing instructions to input the representative dataset to the artificial neural network and compare an output of the artificial neural network to the known output as the periodic performance evaluation.

20. The medium of claim 16, further comprising instructions to:
cause weights of the artificial neural network to be stored in a plurality of memory cells of the memory device prior to operation of the artificial neural network; and
cause weights of the retrained artificial neural network to be stored in the plurality of memory cells.

21. The medium of claim 16, further comprising instructions to operate the retrained artificial neural network.
